(19) United States
(12) Patent Application Publication
(10) Pub. No.: US 2003/0055910 A1
(43) Pub. Date: Mar. 20, 2003

(54) Method and apparatus to manage data on a satellite data server

(75) Inventors: Lisa D. Amini, Yorktown Heights, NY (US); Ralph M. Demuth, Bingen (DE); C. Marcel Kinard, Cary, NC (US); Marina Libman, Pikesville, MD (US); Nelson R. Manohar, New York, NY (US); Chitra Venkatramani, Roslyn Heights, NY (US)

Correspondence Address: FLEIT, KAIN, GIBBONS,, GUTMAN & BONGINI, P.L., ONE BOCA COMMERCE CENTER, 551 NORTHWEST 77TH STREET, SUITE 111, BOCA RATON, FL, 33487, US

(73) Assignee: INTERNATIONAL BUSINESS MACHINES CORPORATION, Armonk, NY

(21) Appl. No.: 09/956,583

(22) Filed: Sep. 19, 2001

(51) Int. Cl. G06F 15/16

(52) U.S. Cl. 709/214; 709/231

(57) ABSTRACT

A data server for use in caching streaming media or other large data objects at locations remote from a central server. The data server monitors data requests by one or more client computers to determine if a streaming media data object satisfies the requirements for storage in the data server. The data server utilizes an intelligent caching scheme to maximize the efficiency of data storage in the data server. The data server of the example embodiment is modular so as to accept commercially available streaming media data server components for individual streaming media formats, such as Real Networks, QuickTime or MPEG.

### BACKGROUND OF THE INVENTION

1. Field of the Invention

This invention generally relates to the field of network data servers, and more particularly relates to network data servers that store copies of large shared streaming media data objects remotely from a central streaming media data server.

2. Description of Related Art

Data communications between and among computers and other devices on electronic communications networks has been steadily increasing. Intercomputer data communications was initially used to exchange short text messages or program files. Earlier computer applications that required or could handle large amounts of data were not in widespread use and when large data transmissions were used, the transmission time of the entire data transmission was generally not critical. Transmission of the same large data file to a large number of computers was also rare.

Digital data communications networks have increased the number of users that are connected to each other as well as the capacity of the communications network that is available between each individual user. Digital communications capacity in excess of 1.5 Mbits/second had been rare and one such connection would usually serve a large corporate facility.

High capacity data lines into end data user facilities are now more economical and available. Communications links with capacity of approximately 1 Mbit/Sec are now readily available and economical for small offices and homes. This high capacity that is available on a widespread basis to individuals and small businesses has greatly increased the amount of data that is communicated over data communications networks, such as the Internet. This increase in capacity to end users, however, is straining the backbone of the data communications infrastructure.

Many companies have implemented company wide data communications networks. These intra-company networks, sometimes referred to as “Intranets,” allow companies to share data among their employees. A company may implement an Intranet which allows access at remote company facilities to data stored in company databases that are either centrally located or geographically distributed. An Intranet that reaches remote company facilities may utilize a low speed data connection for communications of Intranet information into some of the remote facilities.

In order to conserve data transmission resources, network topologies often include data servers that are located near end users of data. These “edge servers” are used to cache data that users have requested from sites further than the edge server so that the data is available for subsequent requests. The caching of data in edge servers is typically performed by storing all data that any local user requests. These edge servers operate on the assumption that if one user requests a data object, it is likely that others will request the same data object. Intranets may place these edge servers within remote facilities in order to reduce the load on the communications link to the remote facility and to provide faster access from the end-user to the data that is cached in the edge server.

The proliferation of higher power computers, the development of digital video and audio compression technologies and high-speed data communications connections have resulted in the widespread transmission of digitized video and audio that can be played in real time. Digitized audio and video which is distributed to and played by computers may include entertainment media, training videos, news broadcasts concerning general interest or company matters as well as other information. These digitized audio and video presentations are typically stored on a centralized server and are communicated to the end viewer over a high speed digital communications network to a computer, where the video is then viewed in real time. The data containing these digitized video and audio files must be delivered to the end computer within certain time restraints in order to ensure uninterrupted viewing at that computer. These digitized video and audio files, which are transmitted and viewed in real time, are referred to as “streaming media” to reflect the characteristic that the data containing the material is sent within time constraints to ensure contemporaneous data transmission and playback that utilize reasonable buffering.

Streaming media are available in a variety of formats that conform to either proprietary or standardized formats. Examples of proprietary formats include the “Real Media format” defined by Real Networks (RN) or the “ASF format” defined by Microsoft, among others. Standardized format for streaming media containing video, so-called “streaming video,” include the QuickTime (QT) format defined by Apple Computer and formats standardized by the “Moving Picture Expert Group” (MPEG). Proprietary formats are subject to frequent change by the developers of software used to produce the streaming media data, and even standardized formats are subject to revision. The format of the streaming media data includes not only the data's structure and storage requirements, but also the manner in which the data has to be transmitted over the communications network to the end user. Changes in the streaming media format often require changes to streaming media data servers used to distribute the streaming media data to ensure that the data is transmitted to the end user in accordance with the new format. The software used on streaming media data servers that store and transmit proprietary formats of streaming media data objects utilize software provided by the vendors supporting those proprietary formats. Besides the data transmission protocol, proprietary servers and players employ proprietary control protocols to communicate controls messages like Play, Pause, Stop etc., to each other. Using the server software provided by those vendors allows easy updating of the software when media format changes or control protocol changes occur since the server software may simply be replaced. Servers which do not simply use the proprietary software provided by the format vendors require re-implementing or reverse engineering of the processing methods used by the format vendors, a process which must be repeated with each change or upgrade in each format or protocol

The prior art therefore does not have an apparatus or method that intelligently caches large shared streaming data objects that are transferred over a network so as to more effectively utilize caching resources. The prior art further does not have an apparatus that intelligently caches large shared streaming data objects that can be easily installed into existing communications networks.

### SUMMARY OF THE INVENTION

The present invention provides a system for intelligently storing large shared streaming data objects on a caching streaming media data server that comprises a replication manager and streaming media data object storage. The streaming media data object storage is electrically coupled to the replication manager and is configured to store one or more large shared streaming data objects in response to a determination by the replication manager to do so. The streaming media data object storage supports specialized delivery requirements by storing large shared streaming data objects such that they are accessible by specialized delivery software and by processing user requests for delivery of a large shared streaming data object so as to use that specialized delivery software to serve the request. The replication manager makes a decision to store a large shared streaming data object by examining one or more user requests for that large shared streaming data object along with the characteristics of the large shared streaming data object. The replication manager may also incorporate administrator specified directives in the decision of what objects should be stored in the intelligent edge server.

The present invention also provides a method for managing the storage of one or more large shared streaming data objects on a caching large shared streaming data server that comprises the steps of accepting a plurality of requests for a large shared streaming data object, determining a pattern within the plurality of requests and performing a large shared streaming data operation in response to the step of determining a pattern.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings.

FIG. 1 is a schematic block diagram illustrating the network elements and the components of the intelligent edge server in accordance with an example embodiment of the present invention.

FIG. 2 is an operational flow diagram illustrating an exemplary processing flow for the operation of the intelligent edge server.

FIG. 3 is an exemplary request data record illustrating the data components stored by the intelligent video edge server for each large shared streaming data object request made by a client.

FIG. 4 is a data flow diagram for the replication manager component of the intelligent edge server.

FIG. 5 is a processing flow diagram illustrating the processing associated with receiving a large shared streaming data object request in an example embodiment of the present invention, which could lead to a cache replacement.

FIG. 6 is a processing flow diagram for cache replacement processing in an example embodiment of the present invention.

FIG. 7 is a processing flow diagram for “Garbage Collection” processing in an example embodiment of the present invention.

FIG. 8 is a processing flow diagram illustrating the streaming data object delete console command processing of an example embodiment of the present invention.

FIG. 9 is a processing flow diagram for a “push storage” console command of an example embodiment of the present invention.

### DESCRIPTION OF THE ILLUSTRATED EMBODIMENTS

The present invention, according to an example embodiment, overcomes problems with the prior art by caching large shared streaming data objects close to the client and by applying an intelligent algorithm to decide which large shared streaming data objects are to be stored and retained in the streaming media data object cache.

Features, and advantages of the present invention will become apparent from the following detailed description. It should be understood, however, that the detailed description and specific examples, while indicating example embodiments of the present invention, are given by way of illustration only and various modifications may naturally be performed without deviating from the present invention.

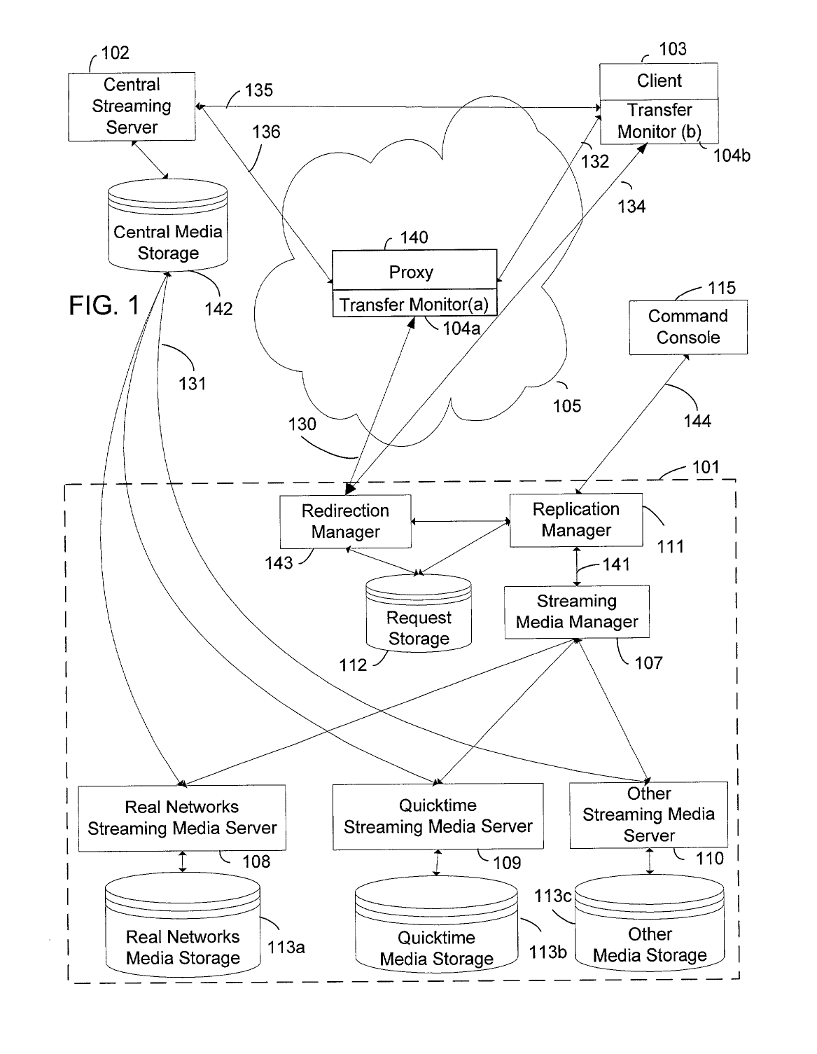

The illustrated embodiment of the present invention is embodied in a dedicated network data server, referred to as an intelligent edge server, that is intended to be located remotely from a central server and which may be reached by clients at lower costs, e.g., over a shorter communications path, than the communications path to the central server. FIG. 1 is an exemplary schematic representation of the network environment in which the present invention is intended to operate. FIG. 1 shows one client computer 103 that is connected through a communications network 105 to an example central server 102 through a communications path 135. Communications path 135 may be a virtual communications link implemented by the communications network, such as the Internet. The present invention may also be used with other data communications links, as is described below. The client computer 103 in the following description of the illustrated embodiment will be referred to as simply a “Client” 103 and is a computer that will receive and present a streaming media object to a user. The central server 102 is a server that stores, in the central media storage 142 an original copy of streaming media data object that defines a streaming media presentation.

FIG. 1 shows an example with only one client 103 and one central server 102 to simplify the explanation of the present invention. The illustrated embodiment is intended to operate in an environment where there are many clients and central servers, although the present invention will also operate in the one central server 102 and one client 103 environment shown. The communications networks that may effectively utilize the present invention include, for example, networks operated by Internet Service Providers (ISPs), Corporate or Enterprise networks, Corporate Intranets. These communications networks may also include networks that interconnect clients through wired, terrestrial radio, satellite or other communications links that use one of or a combination of point-to-point or broadcast connections.

In the operation of an example communications network that does not have an embodiment of the present invention, a client 103 requests a streaming media data object from the central server 102 and the central server 102 responds by transmitting the requested streaming media data object to the requesting client. These two communications occur over the network data path 135. An example embodiment of the present invention is installed into the existing Internet network through the connection of an intelligent edge server 101 onto the shared communications resource, the Internet in this example, which was used by the client to communicate with the central server 102. The illustrated embodiments of the present invention further use a transmission monitor 104a or 104b to monitor communications between the client 103 and central server 102. The transmission monitor 104a or 104b of example embodiments monitor streaming media data object requests and/or streaming media data objects being transmitted to the client 103 to determine if the client 103 is requesting or receiving a streaming media data object. If the client is requesting or receiving a streaming media data object, a descriptor of the streaming media data object is relayed to the intelligent edge server 101. The transmission monitor 104a used in an example embodiment of the present invention is a monitoring process operating in conjunction with an Internet proxy server 140 serving the client 103. Alternative embodiments may use a monitoring process 104b that executes in the client computer 103, such as a plug-in module for a web browser program. Using a monitoring process 104b that operates in the client computer may require configuration of all of the client computers as they are added to the network and reconfiguration as the streaming media formats or the intelligent edge server request data requirements change.

The example embodiment of the present invention adds functionality to the existing web proxy server 140 used by the network and the client 103. The web proxy server 140 accepts data object requests from clients over data link 132, determines from which server to obtain the requested streaming media data object and requests that data object over data link 136. In network implementations with local caching data servers, the proxy server 140 further determines whether the requested data object has been stored in a local data server and, if so, on which local data server the object is stored. The selected server, central server 102 in the illustrated environment, then replies by communicating the requested data object to the web proxy server 140 over path 136, which in turn transmits the requested data to the client over data path 132. The present invention may insert a monitoring process 104a into any network device, such as a gateway or router, which is capable of differentiating network packet types. Cisco Systems, Inc. of San Jose, Calif. is a manufacturer of network router devices that perform packet differentiation.

The intelligent edge server 101 of the illustrated embodiment operates as a streaming media cache to store streaming media data objects which meet certain criteria, as described below, and to then retransmit those streaming media data objects as they are subsequently requested by client computers. The intelligent edge server 101 of the illustrated embodiment incorporates separate components that act as local streaming media servers. FIG. 1 shows a RealNetwork server 108, MPEG server 109, and an example Other server 110. The streaming media servers 108, 109, and 110 are modular components in the design of the illustrated embodiment and may be changed or updated as new servers become available. The streaming media servers 108, 109 and 110 of the illustrated embodiment store streaming media data in the RealNetworks (trademark) media storage 113a, the Quicktime media storage 113b and the other media storage 113c, respectively.

Requests for large shared streaming data are processed within the intelligent edge server 101 by the redirection manager 143. The redirection manager 143 determines if a requested streaming media data object is stored within an intelligent edge server 101. If the requested streaming media data object is stored in an intelligent edge server 101, the redirection manager 143 of the illustrated embodiment causes a message to be relayed to the client computer 103 which directs the client computer to receive the streaming media data object from one of the servers 108, 109 or 110 in the intelligent edge server 101 which has stored it.

The streaming media manager component 107 of the illustrated embodiment coordinates the operation of the streaming media servers. The illustrated embodiment also incorporates other functionality into the streaming media manager component 107. The streaming media manager component 107 of the illustrated embodiment provides an abstraction layer through which the top level processing of the streaming media manager may communicate with one or more streaming media servers.

The Replication Manager component 111 accepts push/delete commands 144 from the command console 115 as well as streaming media data requests 130,134 from the transfer monitor 104a or 104b respectively. The replication manager 111 formulates generic commands 141 to add or delete a large shared streaming data object. The replication manager 111 then issues those generic commands 141 to the Streaming Media Manager 107. The Streaming Media Manager 107 accepts the generic commands, determines the streaming media data format of the large shared streaming data object and issues the proper command to the proper Media Server 108, 109 or 110. The proper Media Server is the data server for the particular format of the large shared streaming data. Many Embodiments of the present invention will have a plurality of media servers to handle different formats of streaming media data objects. The example embodiment 100 shows Media Servers which includes servers for streaming media in formats established by RealNetworks 108, Apple (QuickTime) 109 and others 110. The explanation of the operation of the abstraction layer structure within the streaming media manager 107 does not depend upon the streaming media format being processed. The media servers 108, 109 and 110 in the illustrated embodiment are three instances of servers which process RealMedia, Quicktime or another streaming media data format.

In the example embodiment, a streaming media manager 107 is installed on each of the local systems where a streaming media server installed. In summary, the streaming media manager 107 accepts abstract commands from the replication manager and translates the abstract command into the corresponding command for a streaming media server being controlled by the streaming media manager 107. In the example embodiment, the streaming media manager 107 similarly accepts events generated by the streaming media server and forwards those events to the replication manager for processing. The streaming media manager component 107 of the illustrated embodiment may be configured to also compile streaming media data object request statistics or insert advertising or other messages into the streaming media. The streaming media manager component 107 may also perform security processing that is associated with the streaming media data objects. The illustrated embodiment of the present invention further use a command terminal 115 to configure, control and query the various components of the intelligent edge server 101.

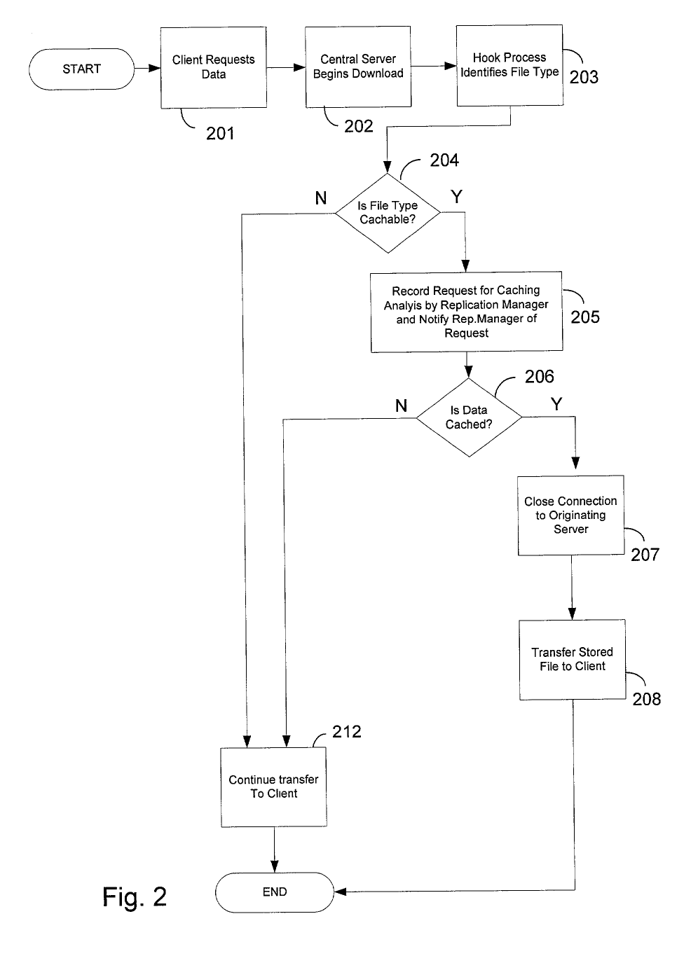

FIG. 2 illustrates the processing associated with a data request that is performed by an example embodiment of the present invention. In the processing flow described in FIG. 2, a client 103 initiates the process in step 201 by requesting a streaming media presentation from a central server 102 over the Internet. The central server 102 responds in step 202 by initiating the transmission of the streaming media. Transmission of the streaming media object involves first providing transmission method information to the client. This transmission method information is often requested over a Hyper-Text Transfer Protocol (HTTP) connection. The transmission method information specifies the streaming media data type and whether the streaming media data will be transmitted over this connection or if one or more separate channels must be established to transport the streaming media data and associated control data. Streaming media data are typically divided into a large number of relatively short packets for transmission over the Internet. The example embodiment of the present invention uses the data type specification included in the HTTP data to identify the type of data being transferred to the client 103.

The transfer monitor 104a of the example embodiment is a process that operates in the web proxy server 140 through which client 103 communicates through the Internet. The transfer monitor 104a performs steps 203 and 204 by monitoring packets being transferred to and/or from the client 103 and identifying the type of data being transferred. The client request for a large streaming media data object could be either for a descriptor identifying that object or the media object itself. In the former case, the descriptor is intercepted by the transfer monitor and the redirection manager 143 modifies the descriptor to point to the local copy of the streaming media data object if the object is stored within an intelligent edge server 101. The replication manager 143 leaves the descriptor unmodified if the streaming media data object is not stored in an intelligent edge server 101. If the request is for the streaming media data object over—the HTTP protocol, then a temporary redirect message is sent back to the client 103 to instruct the client computer 103 to retrieve the file from the local media server which is storing the object, e.g. server 108, 109 or 110. The transfer monitor of the illustrated embodiment identifies the type of data in step 203 by extracting the data type identifier provided under the HTTP protocol. The transfer monitor of the illustrated embodiment then determines in step 204 if the data type corresponds to the descriptor of a streaming media format that the intelligent edge server 101 is configured to process. If the data type is not one of the streaming media formats processed by the intelligent edge server 101, then there is no further interaction by the present invention and the transfer of the descriptor continues in step 212. If the data transfer is a streaming media format that is processed by the intelligent edge server 101 and that server is storing that object, then the communications path in an example embodiment will be reconfigured to cause the descriptor of the streaming media data object in one of the local media server 108, 109 or 110 to be transmitted from the intelligent edge server 101 to the client. If the streaming media data is to be communicated directly over the HTTP channel, the intelligent edge server 101 provides enough information to the client 103 to allow the client 103 to retrieve the object from the intelligent edge server 101. In one embodiment, this is accomplished by returning a message to the client 103 that indicates the streaming media data object has been temporarily relocated to the intelligent edge server 101. In that embodiment, the message also contains the network location of the media server 108, 109 or 110 where the streaming media data object is stored. If the large shared streaming data object is to be communicated over a separate channel, then that embodiment modifies data returned to the client such that the separate channel specified is established with an intelligent edge server 101, instead of the central server 102. An identifier of the streaming media data object is communicated to the intelligent edge server 101 over communications link 130. In the illustrated embodiment, the individual streaming media data objects are identified by the storage location of the streaming media data object, such as a server IP address, directory and file name.

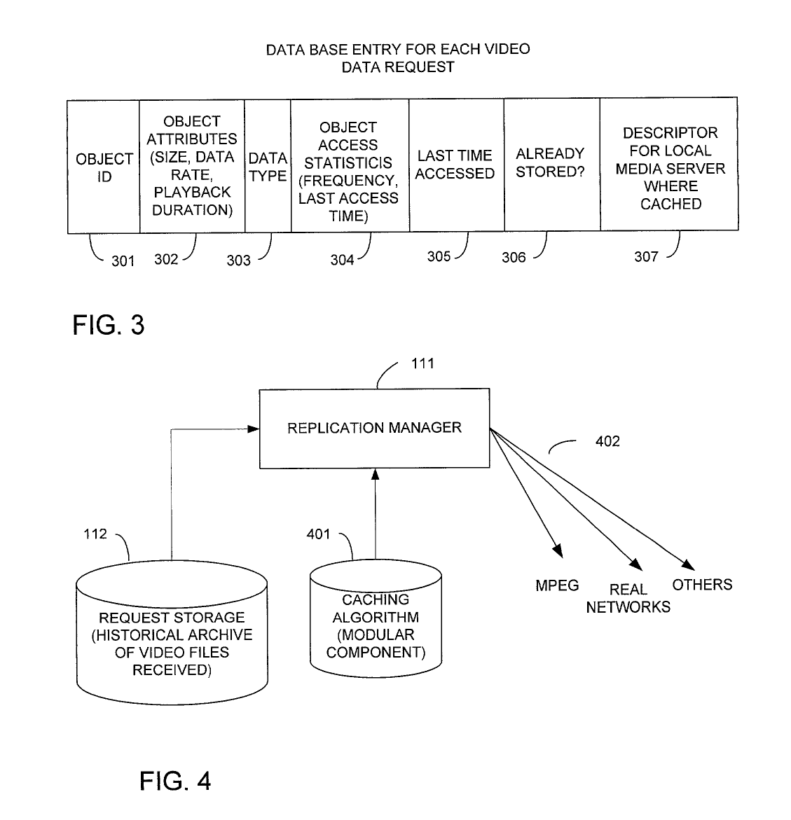

If the data transfer is identified to be a streaming media format processed by the intelligent edge server 101, processing continues with step 205 wherein a description of the streaming media data object requested by the client is stored into the request storage 112 data base table. The request storage 112 data base table is maintained within the intelligent edge server 101 of the illustrated embodiment. The format of the streaming media request information 300 that is stored in the request storage 112 is shown in FIG. 3 and is described in more detail below. The request data 300 in the request storage 112 data base table is analyzed to determine if a streaming media data object should be cached, as is described below. After storage into request storage 112, the processing in the intelligent edge server of the illustrated embodiment determines in step 206 if the requested streaming media data object is currently stored in the streaming media data cache maintained within the intelligent edge server in media storage 113.

If the requested streaming media data object is stored in media storage 113, the intelligent edge server 101, in step 207, causes the connection over path 136 to the central server 102 to close. The illustrated embodiment utilizes processing in the transfer monitor 104a, which operates in the Internet proxy server 140 in the illustrated embodiment, to command the Internet proxy server 140 to terminate the connection. Further, information is also provided to the transfer monitor 104a that specifies the location of the cached copy of the streaming media data object. The transfer monitor 104a returns this information so that the client 103 can initiate transfer of the cached streaming media data object to the client 103 over path 134 from media storage 113. The intelligent edge server 101 utilizes the appropriate streaming media server component 108, 109 or 110 as required by the streaming media data object format.

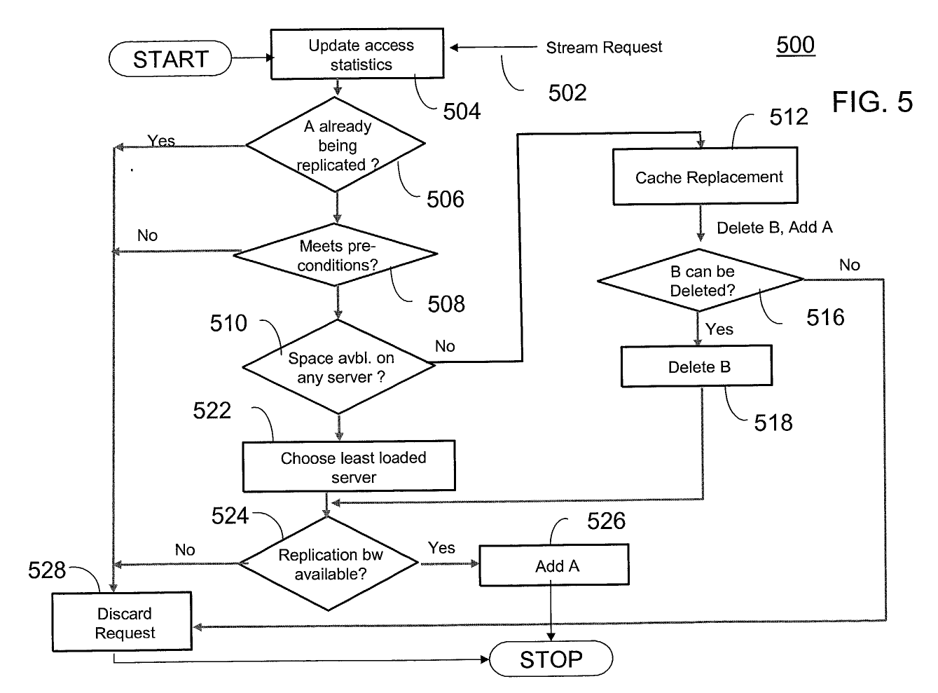

If the processing determines in step 206 that the requested streaming media data object is not stored in the data cache, it returns the response from the central server, back to the client. The replication manager is also notified of the request in step 205. The replication manager considers the history of streaming media data requests to determine if the object should be stored in the data cache according to processing described in FIG. 5.

The format of the request data 300 that is stored by an example embodiment in request storage 112 is illustrated in FIG. 3. The request data 300 stored in the request storage 112 is dependent upon the algorithm used to determine which streaming media objects to store in the cache. The example embodiment uses a modular architecture wherein different streaming media caching algorithms may be configured. The example request data 300 includes an object identifier 301. One embodiment of the present invention uses the network address and file name as the object identifier 301 to identify the streaming media data object. Object attributes such as the object's size, streaming rate are stored in the streaming media object attributes 302. The streaming media data object format, such as RealMedia, MPEG or otherwise, is stored in the data type field 303. Streaming media object access statistics such as the number of times it was requested is stored in Access Frequency 304. The time that the streaming media object was requested, or the time that the streaming media data object transfer began if that is the event monitored by the transfer monitor 104a or 104b of a particular embodiment, is stored in the time of request field 305. A Boolean value indicating whether the streaming media object is currently stored in the cache is contained in the “Already Stored?” data field 306. And if it is stored locally, data field 307 identifies the network address and the file name on the media server such as 108, 109 or 110 where the cached copy of the object is located.

FIG. 4 illustrates the data flows associated with the cache determination processing performed by the replication manager 111. The replication manager of the example embodiment utilizes a modular architecture whereby caching algorithms may be readily modified or substituted. The parameters of the caching algorithm are stored in the caching algorithm definition 401. The replication manager accesses the request storage 112 to obtain request data 300 relating to the number of requests for each streaming media data object. The request data 300 from the request storage 112 is processed according to the algorithm defined in the caching algorithm definition 401 to determine which streaming media objects are to be stored in the streaming data cache maintained by the intelligent edge server 101 in media storage 113. Once a determination of which object to cache and possibly which ones to delete to make room for the new object is made, the replication manager issues the associated caching commands to the Streaming Media Manager 107.

The replication manager processing flow 500 that is performed by an example embodiment of the replication manager 111 is shown in FIG. 5. The replication manager processing flow 500 is shown for an embodiment which makes caching determinations as each stream request is received and manages the data storage space on a plurality of media servers such as 108, 109 and 110. The processing begins with step 504 when a request 502 for a streaming media data object is received from transfer monitors 104a or 104b. The request storage 112 is updated in step 504 to reflect the new streaming media data request 502. The processing then advances to step 506 where the streaming media data objects being downloaded into an intelligent edge server 101 are examined to determine if the requested streaming media data object is already being downloaded. If the requested object is in the process of being downloaded into an intelligent edge server 101, processing within the replication manager 111 advances to step 528 and no further action is taken by the replication manager 111 for this request. If the data is not in the process of being downloaded into an intelligent edge server 101, processing continues in step 508.

Processing in step 508 determines if the requested streaming media object satisfies the caching conditions of the intelligent edge server 101. These conditions may be externally specified thresholds such as the number of hits or the minimum data rate of the object which must be satisfied before an object can be considered for caching. Embodiments of the present invention may be configured to not cache data objects which are delivered at a low data rate, although the object itself may be large, because the communications system will not be overly taxed by repeated delivery of low data rate objects from the central server 102. If the requested streaming media data object does not meet the requirements to be cached, processing advances to step 528 where no further processing is performed by the replication manager 111 for this request.

If the requested data object does meet requirements to be cached, the processing in step 510 determines if there is storage space available in the media storage 113 of any of the media servers 108, 109 or 110 that supports the streaming object's format. The illustrated embodiment may work with a number of media servers which operate in conjunction to perform caching operations. If there is space available on one or more media serves, the replication manager will develop a server list 520 that describes each media server with available space and how much storage space each server has available. Processing then continues to step 522 wherein the server list 520 is examined to determine which media server is least loaded.

If step 510 determines that there is not space available on any server, processing continues with step 512 to perform cache replacement processing as is described in detail below. Cache replacement processing performed in step 512 determines if a currently stored streaming media data object may be deleted, and if a currently stored object may be deleted, the object is identified. If the streaming media data object identified in step 512 may not be deleted, as is determined by processing in step 516, processing advances to step 528 and no further processing is performed by the replication manager 111 for this request. If the processing in step 516 determines that the streaming media data object identified in step 512 may be deleted, the file is deleted in step 518 according to the processing identified below. Processing then continues with step 524.

The processing in step 524 is performed after step 522 or step 518, according to the processing flow followed above, to determine the available communications bandwidth that may be used to receive the requested streaming media data object. If there is sufficient communications bandwidth available, processing continues with step 526 and the requested object is received by the intelligent edge server 101 and stored in the media storage 113. If there is not enough communications bandwidth available, the processing advances to step 528 wherein no further processing is performed by the replication manager for this request.

The illustrated embodiment uses a modular architecture that allows ready modification or replacement of the implemented streaming media data caching algorithm. The analysis performed in step 512 is used to base a decision to store the requested streaming media data object in the data cache maintained in media storage 113. If the streaming media data is to be cached, example embodiments request the streaming media data object from the central server 102 and store the streaming media data object in the cache. Alternative embodiments may capture the streaming media data object during the transfer to the client 103, or a separate transfer to the intelligent web server 101 may be used over link 131.

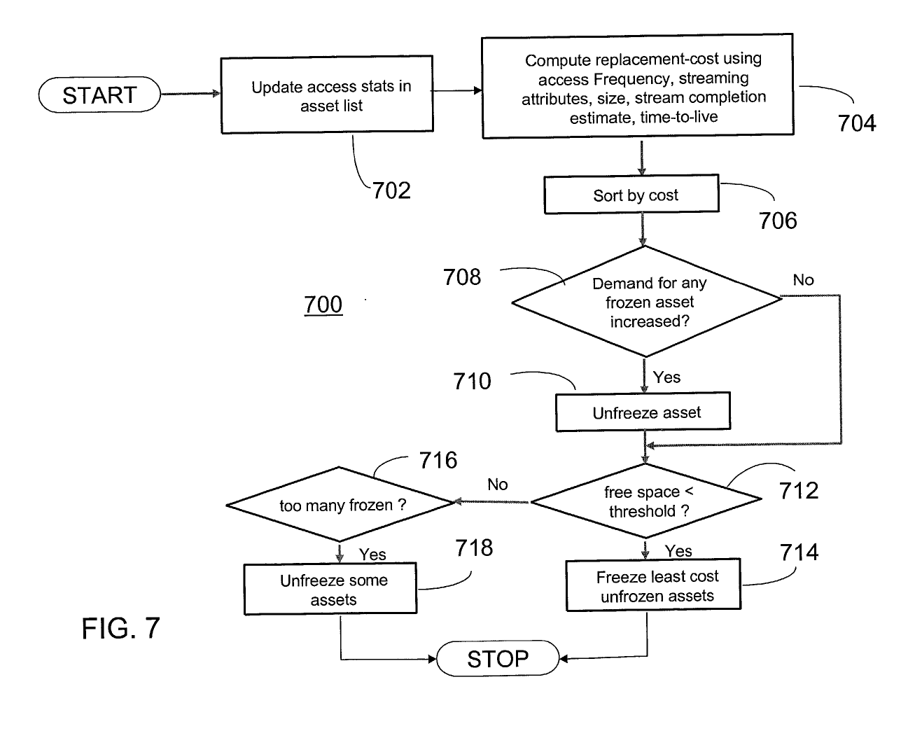

As an addition to the processing shown in FIG. 5 wherein processing to determine whether to store streaming media data objects is performed in response to each request, alternative embodiments may use an independent, asynchronous process to cache popular objects. The former is to respond to sudden surge in requests for a large streaming object and the latter is to do a more long-term trend analysis to determine the popular objects to cache. The illustrated embodiment shows a Garbage Collector process (FIG. 7) that periodically performs a full analysis of the request history for each streaming media data object that is stored in request storage 112 to determine which streaming media data objects to cache and which are no longer required to be held in the cache. An example embodiment of the present invention performs this full analysis approximately every thirty minutes. Caching decisions are also performed on each request in step 512 in the illustrated embodiment to determine if there is a streaming media data object for which there is a sudden demand. Such processing would be concurrent with the more detailed cache analysis that is performed independently.

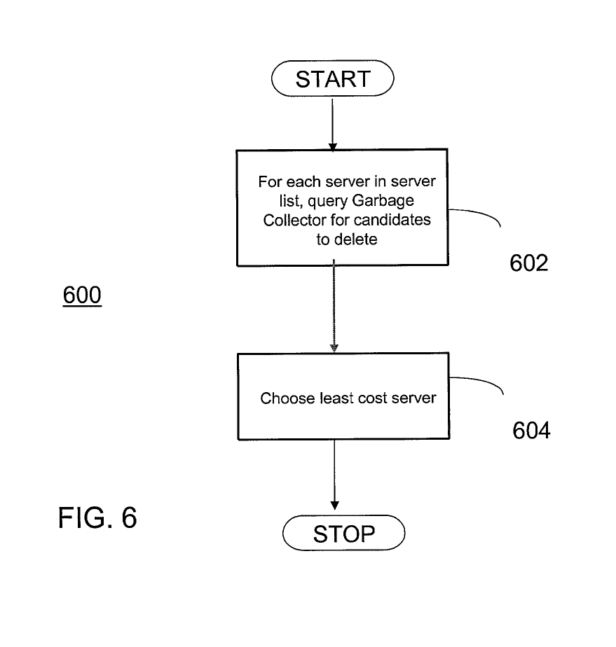

FIG. 6 illustrates an example cache replacement processing flow 600 which is performed in step 512 above. The cache processing may utilize the history of requests for the streaming media data objects that is stored in request storage 112. The cache processing may use data caching algorithms such as LRU (Least Regularly Used); Size adjusted LRU by Aggarwal et al.; LFU (Least Frequently Used) or Resource Based Caching by Renu Tewari et al. These algorithms are described in the following publications: Resource Based Caching: “Resource-Based Caching for Web Servers” by Renu Tewari, Harrick Vin, Asit Dan and Dinkar Sitaram, as published in Proceedings of MMCN, 1998; Size Adjusted LRU: “Caching On The World Wide Web” by Charu Aggarwal, Joel Wolf and Philip Yu, IEEE Transactions on Knowledge and Data Engineering, Vol. 11, No. 1, January/February 1999; and LRU and LFU algorithms: “Modern Operating Systems” by Andrew S. Tanenbaum, 2^{nd} Edition, Prentice-Hall, 2001. All of the above identified publications are hereby incorporated herein by reference.

Cache replacement processing starts with step 602 wherein a query is communicated to a Garbage Collector module to determine if there are streaming media data object(s) to delete in each selected media server in the server list 520. The request is handled by a garbage collection process 700 within the replication manager 111 and which is described below. The garbage collection process in the replication manager returns the identification and characteristics of the candidate streaming media data objects that are currently stored and which may be deleted. A list of characteristics of candidate objects on each server is assembled and processing continues with step 604. The processing in step 604 determines which currently stored streaming media data object is best to delete and chooses the media server 108, 109 or 110 which is storing that object.

The Garbage collection process runs periodically in order to maintain a threshold of free space into which new objects may be stored and the garbage collection process also maintains a sorted list of objects from the most to the least valuable. If there are objects which are not very valuable, the Garbage collector may choose to “freeze” them (mark them for deletion) whereby all future requests to that object are redirected to the central server 102. This is to permit the object to be deleted when the current streams to the client 103 complete. The replication manager 111 queries this process for candidates to delete when making a caching decision.

The processing flow 700 of an example embodiment is shown in FIG. 7. The garbage collection processing flow 700 starts in step 702 by updating the request statistics derived from the request data stored in the request storage 112. Once the request statistics are updated, the “cost” of deleting a currently stored streaming media data object is calculated in step 704 based upon the request statistics for each streaming media data object. The “cost” of deleting refers to the value of the cached streaming media data object, which is dependent upon the frequency that the object is requested by clients 103, the streaming attributes of the object (e.g. bandwidth), the size of the object, the time it will take for currently outgoing multimedia data streams to complete their transfer (stream completion estimate) and a specified “time to live” value if the object is cached under a “push” condition, as is described below.

A list of cost of deleting currently stored streaming media data objects is produced in step 704 and the list is sorted, in step 706, by the cost of deleting each object. Processing in this example embodiment then continues with step 708 to determine if the demand for a frozen streaming media data object has increased. A currently stored streaming media data object which is to be deleted is “frozen” prior to being actually deleted, as is described in delete processing 800, below. If the demand for a frozen object has increased, as is determined by step 708, the frozen object is unfrozen (and therefore will not be deleted) in step 710 and processing continues in step 712. If demand has not increased for a frozen streaming media data object, processing advances from step 708 to step 712.

The available streaming media storage space within media storage 113 is determined in step 712 and compared to a threshold configured for the intelligent edge server 111. If the available space is below that threshold, the least cost objects on the list sorted in step 706 are frozen and thereby marked for deletion.

If the available space determined in step 712 is not below the configured threshold, the number of streaming media data objects which are frozen is examined and if that number is above another threshold configured for the operations of the intelligent edge server 111, some of the frozen streaming media data objects are unfrozen in step 718 and therefore will not be deleted.

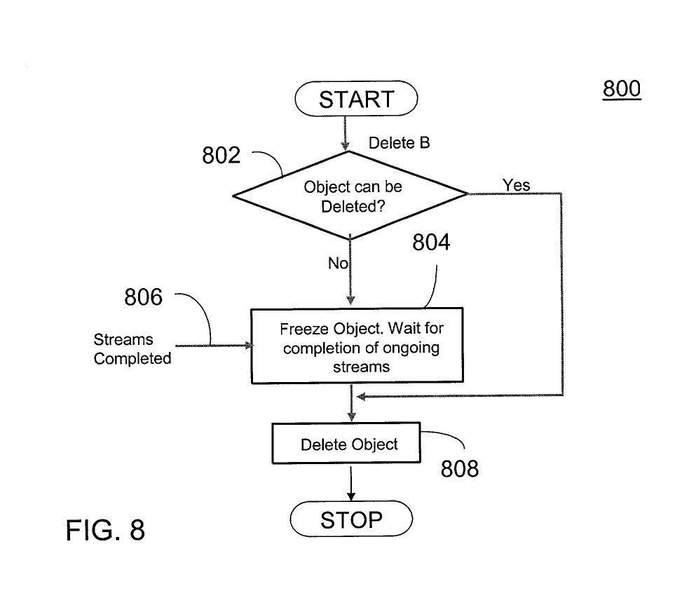

Delete command processing 800 of an example embodiment is shown in FIG. 8. When a streaming media data object is to be deleted, delete processing 800 starts with examining, in step 802, whether the data object may be deleted.

A streaming media data object may be deleted in this example embodiment if no clients 103 are receiving the data from that intelligent edge server 101. If a stream to a client 103 is active (i.e., a client 103 is currently receiving data from the object), the object may not be immediately deleted.

If no clients are receiving data from a currently stored streaming media data object, step 802 determines that the object may be deleted and processing continues with step 808. If the processing in step 802 determines that an object may not be deleted, processing advances to step 804. The processing in step 804 “freezes” the currently stored streaming media whereby no further client requests for that object will be transmitted from that intelligent edge server 101. The processing in step 804 suspends until delivery of data from that streaming media data object is completed. Once all delivery of the streaming media data is completed, the streams completed event is delivered to the processing in step 804 and the streaming media data object is deleted in step 808.

In addition to determining the streaming media data objects to be stored through analysis of streaming media data object requests by one or more clients 103, the intelligent data server 101 may receive a command over the communications network, through server data link 131, to store a particular streaming media data object for a specified period. Such a command is referred to as a “push” command and could be transmitted from a centralized replication manager operating with the central server 102. Push commands may also be entered through console 115. The difference between addition of an asset due to a caching decision and due to a console commanding the illustrated embodiment is that the addition of the streaming object in the latter case is a higher priority. This results in all attempts being made to bring the object into the cache.

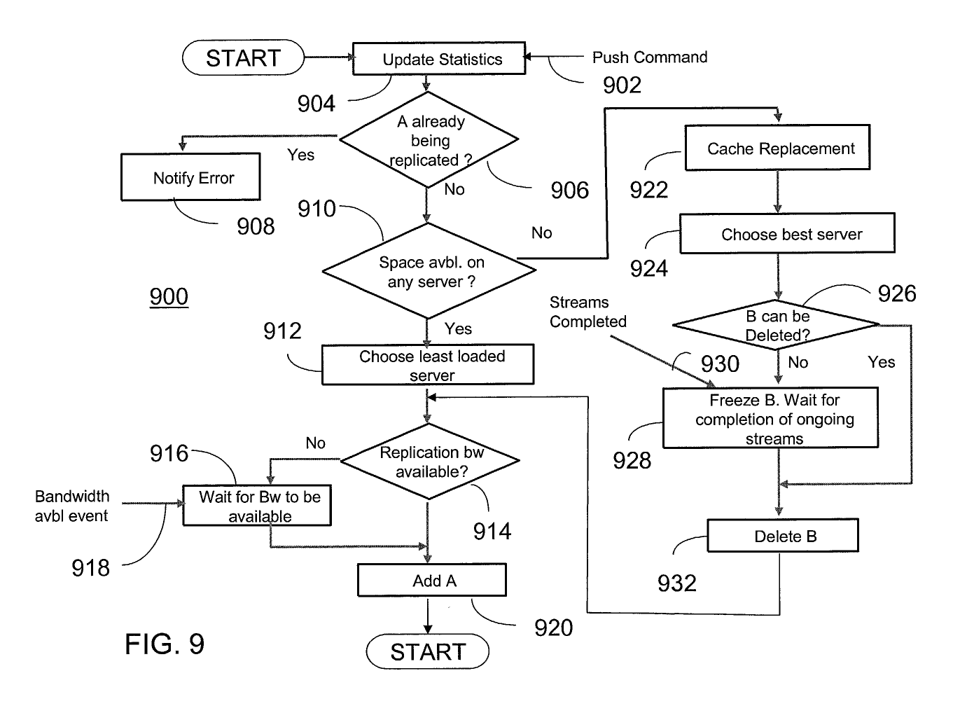

An example of push processing 900 that is performed in response to the receipt of a push command is illustrated in FIG. 9. Processing starts with step 904 wherein a push command 902 to store a particular large shared streaming data object is received. Processing continues with step 906 to determine if that large shared streaming data object is already in the process of being replicated within an intelligent edge server 101. If the object is already stored, an error is notified in step 908 to the originator of the push command 902 and processing for this command stops. If the object is not already in the process of being stored, processing advances to step 910 to determine if there is space available in any server. The processing in step 910 is similar to the processing described in step 510 above. If space is available on a server, the least loaded server is selected in step 912. The processing in step 912 is similar to the processing described in step 522 above.

If the processing of step 910 determines that there is not space available on any server, processing continues with step 922 to perform the cache replacement processing 600, described above. The best server is then determined in step 924 from the data produced by the cache replacement processing in step 922. Step 926 then determines if the streaming media data object may be deleted (e.g., examines if there are any clients currently accessing the data from that intelligent edge server 101). If the object may be deleted, processing advances to step 932 wherein the object is deleted. If the processing of step 926 determines that the object may not yet be deleted, processing continues with step 928 wherein the object is “frozen” to disable new streaming access to the data object from being initiated. The processing of step 928 then suspends until the streaming access to the data object ceases and a “streams complete” event is delivered to the processing of step 928. The processing then advances to step 932 and the object is deleted.

The processing after steps 912 or 932 then determines, in step 914, whether there is sufficient communications bandwidth available between the central server 102 and the intelligent edge server 101 to transfer the streaming media data object that is specified in push command 902. If insufficient bandwidth is determined to be present, processing continues to step 916 wherein the bandwidth available for communications is monitored. Once communications bandwidth becomes available, which is signaled by the bandwidth available event 918, processing continues with step 920 wherein the streaming media data object specified in the push command 902 is added to the media storage 113. The addition of the object in the example embodiment is performed by receiving the streaming media data object from the central server 102 and storing the object in media storage 113 through the use of the proper media server.

The present invention can be realized in hardware, software, or a combination of hardware and software. A system according to an example embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods. Computer program means or computer program in the present context mean any expression, in any language, code or notation, of a set of instructions intended to cause a system having an information processing capability to perform a particular function either directly or after either or both of the following a) conversion to another language, code or, notation; and b) reproduction in a different material form.

Each computer system may include, inter alia, one or more computers and at least a computer readable medium allowing a computer to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the computer readable medium may comprise computer readable information in a transitory state medium such as a network link and/or a network interface, including a wired network or a wireless network, that allow a computer to read such computer readable information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for managing storage of one or more streaming media data objects on a caching data server, comprising the steps of:
monitoring a plurality of requests for a streaming media data object;
determining if the streaming media data object satisfies a caching condition; and
performing a data operation in response to the step of determining if the streaming media data object satisfies a caching condition.

2. A method according to claim 1, wherein the step of performing a data operation further comprises the steps of:
requesting the data object from a central server; and
storing the data object within the caching data server.

3. A method according to claim 1, wherein the step of performing a data operation further comprises the step of deleting the data object from the caching data server.

4. A method according to claim 1, wherein the caching condition is based upon at least one of a size of the streaming media data object, a transmission data rate of the streaming media data object, a number of requests for the streaming media data objects and a number of requests for the streaming media data objects over a period of time.

5. A method according to claim 1, wherein the step of monitoring a plurality of requests comprises the step of monitoring data being transferred to one or more client computers.

6. A method according to claim 5, wherein the step of monitoring data being transferred comprises the step of extracting and recording a data type and object identifier being transferred to the one or more client computers.

7. A method according to claim 6, wherein the step of monitoring data being transferred further comprises the step of extracting and recording a size of the streaming media data object

8. A method according to claim 1, wherein the step of monitoring a plurality of requests comprises the step of monitoring streaming media object data requests being transmitted from one or more client computers.

9. A method according to claim 1, wherein the step of accepting a plurality of requests for a data set is performed within a web proxy server.

10. A method according to claim 1, wherein the step of accepting a plurality of requests for a data set is performed within a computer receiving the streaming media data object.

11. A method according to claim 1, wherein the step of performing a data operation is performed by a modular software component provided by a third party vendor.

12. A method according to claim 1, wherein the step of determining if the streaming media data object satisfies a caching condition is performed by a modular software component which can be reconfigured.

13. A method for managing storage of one or more data objects on a caching data server, comprising the steps of:
receiving a command to cache a data object;
receiving the data object; and
storing the data object.

14. A method according to claim 13, wherein the command further comprises a specification of the length of time to retain the data object.

15. A system for intelligently storing data objects on a caching data server, comprising:
a replication manager for determining a data object to cache based upon monitoring a plurality of streaming requests for the data object; and
a data storage, electrically coupled to the replication manager, which is configured to store one or more data objects in response to a determination by the replication manager.

16. A system according to claim 15, wherein the replication manager requests the data object from a remote server.

17. A system according to claim 15, wherein the data storage is further configured to delete the data object.

18. A system according to claim 15, wherein the replication manager determines a data object to cache based further upon at least one of a size of the streaming media data object, a transmission data rate of the streaming media data object, a number of request for the steaming media data objects and a number of requests for the streaming media data objects over a period of time.

19. A system according to claim 15, wherein the replication manager monitors data being transferred to one or more client computers.

20. A system according to claim 19, wherein the replication manager extracts and records a data type and object identifier being transferred to the one or more client computers.

21. A system according to claim 20, wherein the replication manager further extracts and records a size of the streaming media data object

22. A system according to claim 15, wherein the replication manager further monitors streaming media object data requests being transmitted from one or more client computers.

23. A system according to claim 15, further comprises a web proxy server, electrically connected to the replication manager, for intercepting a plurality of requests for the data object and directing a characterization of the requests to the replication manager.

24. A system according to claim 15, further comprising a client computer, electrically connected to the replication manager, which directs a characterization of the requests to the replication manager.

25. A system according to claim 15, wherein the data storage comprises a modular software component provided by a third party vendor.

26. A system according to claim 15, wherein the replication manager comprises a reconfigurable, modular software component to determine the data object to cache.

27. A system for storing one or more streaming media data objects on a caching streaming media data server, comprising:
a replication manager for receiving a command to cache a data object; and
a data storage, electrically connected to the replication manager, for receiving and storing the data object.

28. A system according to claim 28, wherein the command further comprises a specification of the length of time to retain the data object.

29. A computer readable medium including computer instructions for a caching data server, the computer instructions comprising instructions for:
accepting a plurality of requests for a data object;
determining a pattern within the plurality of requests; and
performing a data operation in response to the step of determining a pattern.

30. The computer readable medium according to claim 28, wherein the programming instruction of performing a data operation further comprises the programming instruction of:
requesting the data object from a central server; and
storing the data object within the caching data server.

31. The computer readable medium according to claim 28, wherein the programming instruction of performing a data operation further comprises the programming instruction of deleting the data object from the caching data server.
